(19) United States
(12) Patent Application Publication
(10) Pub. No.: US 2006/0001370 A1
(43) Pub. Date: Jan. 5, 2006

(54) Plasma display screen with blue-emitting phosphor

(75) Inventors: Thomas Justel, Aachen (DE); Walter Mayr, Alsdorf (DE); Peter Schmidt, Aachen (DE); Wolfgang Schnick, Gauting (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/535,462

(22) PCT Filed: Nov. 10, 2003
(86) PCT No.: PCT/IB03/05112

§ 371 Date: May 17, 2005

(30) Foreign Application Priority Data
Nov. 21, 2002 (DE) 102 54 175.2

(51) Int. Cl. H01J 17/49

(52) U.S. Cl. 313/582

(57) ABSTRACT

A plasma display screen comprising a carrier plate, a transparent front plate, a ribbed structure dividing the space between the carrier plate and the fmnt plate into plasma cells, which are filled with a gas, one or more electrodes arrays for generating corona discharges in the plasma cells, and a phosphor layer comprising a blue-emitting phosphor of the general formula (La1-x-yGdx)Si3N5:Cey, where 0≦x<1 and 0<y<0.1.

The invention relates to a plasma display screen comprising a carrier plate, a transparent front plate, a ribbed structure which divides the space between the carrier plate and the front plate into plasma cells, which are filled with a gas, one or more electrode arrays to generate corona discharges in the plasma cells, and a phosphor layer comprising a blue-emitting phosphor.

The principle on which a plasma display screen is based is that a high voltage in a gas with a low gas pressure generates electromagnetic radiation, which may be visible itself or which can be converted into visible light by phosphors.

In a color plasma display screen of customary design, the gas filling is composed of an inert gas, for example xenon, or an inert gas mixture, for example a mixture of helium, neon and xenon. The discharge process involves the generation of ultraviolet radiation in the VUV range, i.e. radiation having a wavelength below 200 nm. This VUV radiation excites the red, green and blue-emitting phosphors (RGB phosphors) in the phosphor layer, thereby causing them to emit visible light in the colors red, green and blue. Thus, unlike conventional fluorescent lamps, the luminescent materials in plasma display screens use the high-energy side of the UV spectrum. Dependent upon the composition of the inert gas mixture and the gas pressure, the VUV emission consists of a single line at 147 nm or of a broad excimer band with a maximum at 172 nm. What results from this is that new demands are imposed on the RGB phosphors in a plasma display screen.

The RGB phosphors constitute the final member of the energy-transfer chain wherein electric energy is converted into visible light in the plasma display screen. The efficiency of a plasma display screen with a phosphor layer is ultimately determined by the electro-optical efficiency of the phosphors, i.e. how completely the visible UV light generated is absorbed in the phosphor and how completely the visible light generated subsequently leaves the plasma display screen in the direction of the viewer.

Among the blue-emitting phosphors europium(II)-activated barium magnesium aluminate is unsurpassed in terms of color properties and electro-optical efficiency. What is problematic, however, is that it is subject to comparatively strong degradation under the influence of VUV radiation. Said degradation is particularly strong under the influence of VUV radiation having a wavelength below 200 nm, and manifests itself as a deterioration of the electro-optical efficiency and a shift of the color point in the green range.

WO 99/34389 discloses a plasma display screen with a phosphor of the general formula Ba₁₋ₑEuₑMnₘMg_{1+δ-m}Al_{10+2f}O_{17+δ+3f}, which exhibits a reduced color shift during the service life of the display screen.

The degradation and color shift of europium(II)-activated barium magnesium aluminate already begins, however, in the production process of the plasma display screen, in which the phosphor layer is exposed to temperatures of 500° C. and higher.

It is an object of the invention to provide a plasma display screen comprising a carrier plate, a transparent front plate, a ribbed structure dividing the space between the carrier plate and the front plate into plasma cells, which are filled with a gas, one or more electrode arrays for generating corona discharges in the plasma cells, and a phosphor layer comprising a blue-emitting phosphor, which plasma display screen is characterized by temperature stability, an improved, faithful color rendition and a higher brightness.

In accordance with the invention, this object is achieved by a plasma display screen comprising a carrier plate, a transparent front plate, a ribbed structure dividing the space between the carrier plate and the front plate into plasma cells, which are filled with a gas, one or more electrodes arrays for generating corona discharges in the plasma cells, and a phosphor layer comprising a phosphor of the general formula (La_{1-x-y}Gdₓ)Si₃N₅OᵥF_{w}:Ce_{y}, where 0≦x<1, 0<y<0.1, 0≦v<0.1 and 0≦w<0.1.

In such a plasma display screen, the blue dot has been shifted to attain a higher color saturation. This has an influence not only on the blue tones but also on all intermediate tones on the blue-green and blue-red lines which can be reached as a result of the enlargement of the display triangle in the blue range. By virtue thereof, a more faithful display of many color tones is possible, resulting in a visible difference. In addition, the color contrast under bright ambient light conditions is increased.

In accordance with a preferred embodiment, the phosphor layer comprises the blue-emitting phosphor LaSi₃N₅:Ce.

The invention also relates to a phosphor layer comprising a blue-emitting phosphor of the general formula (La_{1-x-y}Gdₓ)Si₃N₅OᵥF_{w}:Ce_{y}, where 0≦x<1, 0<y<0.1, 0≦v<0.1 and 0≦w<0.1. Such a phosphor layer can suitably be used as a phosphor layer in light-emitting diodes, particularly UV-LEDs, and in gas discharge lamps. Said phosphor layer is insensitive to thermal loads.

The invention flrher relates to a phosphor (La_{1-x-y}Gdₓ)Si₃N₅OᵥF_{w}:Ce_{y}, where 0≦x<1, 0<y<0.1, 0≦v<0.1 and 0≦w<0.1.

This phosphor is characterized by improved thermal loadability, particularly in an oxygen-containing atmosphere, as compared to Eu(II)-activated barium magnesium aluminate, which can be attributed to the fact that the oxidation reaction of the cerium(III) ion to the cerium(IV) ion has a very high activation energy. As a result, the Ce³⁺-activated nitridosilicate phosphors are thermo and photo-stable.

As a result, also the luminance of this phosphor is not adversely affected in the manufacturing process of the plasma display screen, and the efficiency remains constant for a very long period of time also in the case of excitation by VUV radiation, such as occurs inter alia in, for example, low-pressure gas discharge lamps and VUV-LEDs. Like all cerium(III)-doped phosphors, also said phosphor is further characterized by a very good excitability by UV radiation and by a short decay time t_{1/10} in the range between 2 and 10 ms.

In accordance with a preferred embodiment, the invention relates to a phosphor of the general formula (La_{1-x-y}Gdₓ)Si₃N₅:Ce_{y}, where 0≦x<1 and 0.01<y<0.1.

These and other aspects of the invention are apparent from and will be elucidated with reference to a drawing and an example.

In the drawing:

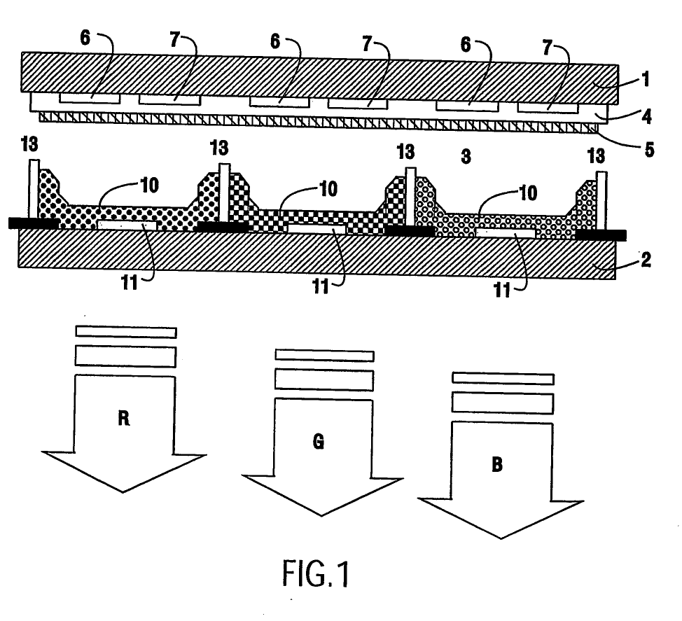

FIG. 1 is a diagrammatic cross-sectional view of a plasma display screen.

The principle on which all types of plasma displays are based is light excitation by UV radiation from a gas discharge. Plasma displays can be divided into DC-addressed display screens and AC-addressed display screens. The difference between them relates to the type of current limitation.

FIG. 1 shows an example of a plasma cell of an AC plasma display. Such an AC plasma display screen is composed of a transparent front plate 1 and a carrier plate 2, which are arranged at a distance from each other and are hermetically sealed at the periphery. The space between the two plates constitutes the discharge space 3 which is bounded by the protective layer and the phosphor layer. Customarily, the front plate as well as the carrier plate are made of glass. Individually drivable plasma cells are formed by a ribbed structure 13 having separating ribs. A plurality of transparent picture electrodes 6, 7 are arranged in the form of stripes on the front plate. The associated control electrodes 11 are provided at right angles thereto on the carrier plate, so that a discharge can be ignited at each one of the crossing points.

The discharge space is filled with an appropriate discharge gas, for example xenon, a xenon-containing gas, neon or a neon-containing gas. The gas discharge is ignited between the picture electrodes 6, 7 on the front plate. To preclude direct contact between the plasma and the picture electrodes 6, 7, the latter are covered with a dielectric layer 4 and a protective layer 5. In the discharge zone, the gas is ionized and a plasma develops which emits VUV radiation.

Dependent upon the composition of the gas in the plasma cell, the spectral intensity of the gas discharge changes. Gas mixtures containing less than 30% by volume xenon emit predominantly resonance radiation at 147 mn, gas mixtures containing more than 30% by volume xenon emit excimer radiation at 172 nm.

The emitted VUV radiation excites pixel-structured red, green and blue phosphors, thereby causing them to emit light in the visible range, as a result of which a color impression is generated. The pixels of the plasma display screen in the three primary colors red, blue and green are formed by a phosphor layer 10 on at least a part of the carrier plate and/or on the walls of the separating ribs in the plasma cells. The plasma cells are each coated with in succession a red, green or blue phosphor. Three juxtaposed plasma cells represent one pixel, which enables all colors to be displayed by mixing said three primary colors.

The phosphor for generating the blue primary color of the general formula is, in accordance with the invention, (La_{1-x-y}Gdₓ)Si₃N₅OᵥF_{w}:Ce_{y}, where 0≦x<1, 0<y<0.1, 0≦v<0.1 and 0≦w<0.1.

The cerium(III)-activated nitridosilicate (La_{1-x-y}Gdₓ)Si₃N₅OᵥF_{w}:Ce_{y}, where 0≦x<1, 0<y<0.1, 0≦v<0.1 and 0≦w<0.1, is based on a nitridosilicate host lattice having the composition LnSi₃N₅. Said host lattice forms a three-dimensional lattice of interlinked SiN₄ tetrahedrons, in which the Ln ions lanthanum(III) and/or gadolinium(III) are included.

The host lattice is doped with less than 10% cerium as an activator. In comparison with oxidosilicate host lattices, the covalent fraction of the bonds and hence the ligand field intensity is increased by the inclusion of nitrogen into the host lattice. Thus, in comparison with the oxidosilicates, the excitation and emission bands are shifted to longer wavelengths.

The doped cerium(III)-activated (La_{1-x-y}Gdₓ)Si₃N₅OᵥF_{w}:Ce_{y}, where 0≦x<1, 0<y<0.1, 0≦v<0.1 and 0≦w<0.1, are prepared in accordance with conventional methods, for example by a solid-state reaction. In such a method, the oxides or carbonates are used as the starting compound. They are mixed, ground and subsequently sintered. As a result, phosphors with a uniform crystal structure are obtained in the form of fine-grain particles having a grain size in the range of 1 to 10 μm.

To manufacture the phosphor layer use can be made of dry coating methods, for example electrostatic deposition or electrostatically assisted dusting, as well as wet coating methods, for example screen printing, dispenser methods, wherein a suspension is introduced using a nozzle moving along the channels, or sedimentation from the liquid phase.

For the wet coating methods, the phosphors must be dispersed in water, an organic solvent, if necessary in combination with a dispersing agent, a tenside and an anti-foaming agent or a binder preparation. Organic and inorganic binders capable of withstanding an operating temperature of 250° C. without being subject to decomposition, embrittlement or discoloration can suitably be used as the binder preparations for plasma display screens.

Although the invention has been described with reference to an AC color plasma display screen, the application of the invention is not limited to this type of plasma display screen, but also includes, for example, DC color plasma display screens and monochromatic AC and DC plasma display screens.

### EXAMPLE 1

To prepare LaSi₃N₅:Ce, a quantity of 11.51 g (191.60 mmol) SiO₂, 10.00 g (30.70 mmol) La₂O₃, 5.584 g (464.96 mmol) graphite powder and 1.22 g (0.62 mmol) CeF₃ are homogeneously mixed, suspended in ethanol and stirred at room temperature for 2 hours. Next the suspension is dried and filled into a corundum boat. This is heated in a tubular furnace in a gas flow of 95% nitrogen and 5% hydrogen to a temperature of 1250° C. within one hour. This temperature is maintained for 2 hours. Subsequently, nitrogen is added to the reducing gas flow and the heating process is continued for three hours at 1450° C. Next, said corundum boat is allowed to cool to room temperature in a reducing gas flow. As a result, a blue-emitting phosphor of the composition LaSi₃N₅:Ce is obtained.

Using the phosphor thus prepared, a plasma display screen in accordance with the known methods was manufactured and tested.

1. A plasma display screen comprising a carrier plate, a transparent front plate, a ribbed structure dividing the space between the carrier plate and the front plate into plasma cells, which are filled with a gas, one or more electrodes arrays for generating corona discharges in the plasma cells, and a phosphor layer comprising a blue-emitting phosphor of the general formula (La_{1-x-y}Gdₓ)Si₃N₅OᵥF_{w}:Ce_{y}, where 0≦x<1, 0<y<0.1, 0≦v<0.1 and 0≦w<0.1.

2. A plasma display screen as claimed in claim 1, characterized in that the phosphor layer comprises the blue-emitting phosphor LaSi₃N₅.

3. A phosphor layer comprising a blue-emitting phosphor of the general formula (La_{1-x-y}Gdₓ)Si₃N₅OᵥF_{w}:Ce_{y}, where 0≦x<1, 0<y<0.1, 0≦v<0.1 and 0≦w<0.1.

4. A phosphor of the general formula (La_{1-x-y}Gdₓ)Si₃N₅OᵥF_{w}:Ce_{y}, where 0≦x<1, 0<y<0.1, 0≦v<0.1 and 0≦w<0.1.

5. A phosphor of the general formula (La_{1-x-y}Gdₓ)Si₃N₅:Ce_{y}, where 0l ≦x<b 1 and 0.01<y<0.1.
